(19) United States
(12) Patent Application Publication
(10) Pub. No.: US 2023/0062592 A1
(43) Pub. Date: Mar. 2, 2023

(54) ANIMAL CAGE LOCK

(71) Applicant: Hebe Studio Limited, Oxfordshire (GB)

(72) Inventors: Simon NICHOLLS, Northants (GB); James TUTHILL, Oxfordshire (GB); Johannes PAUL, London (GB); William WINDHAM, Oxfordshire (GB)

(21) Appl. No.: 17/783,517

(22) PCT Filed: Nov. 30, 2020
(86) PCT No.: PCT/EP2020/083912

§ 371 Date: Jun. 8, 2022

(30) Foreign Application Priority Data
Dec. 10, 2019 (GB) 1918149.4
Dec. 18, 2019 (GB) 1918711.1

(51) Int. Cl. F16B 5/06; A01K 1/03

(52) U.S. Cl. CPC F16B 5/0614; A01K 1/03; F16B 2005/0678

(57) ABSTRACT

A lock (21) for an animal cage (11), the lock (21) being configured for locking a first wire mesh panel (13) of the cage to an adjacent second wire mesh panel (14), the lock comprising: a fastener (29, 31) for coupling the lock (21) to said first panel (13) in the vicinity of a peripheral edge of said first panel; a panel support (36) for supporting a peripheral edge portion of said adjacent second wire mesh panel (14), and a two-part locking mechanism (39, 41) reconfigurable between a first position in which said peripheral edge portion of said adjacent second wire mesh (14) panel is retained in said panel support (36) and a second position where said peripheral edge portion of said adjacent second wire mesh panel (14) can be moved out of said support (36).

### FIELD

This disclosure relates to locks, for example to locks for coupling together wire mesh panels of an animal cage.

### BACKGROUND

It has previously been proposed to keep animals in wire mesh cages. Due to packaging and transportation constraints, it has previously been proposed to provide such wire mesh cages as a number of separate wire mesh panels, which are then assembled together, for example by the purchaser, to form a cage. These panels can conveniently be coupled together by means of a ring clip of the type previously disclosed in our European Patent No. 3211251.

It is usual for such cages to be provided with a door so that access to the interior of the cage may conveniently be had. In one previously proposed arrangement, the door to the interior of the cage is formed by a larger door panel that partly overlaps with an adjacent smaller wall panel of the cage. A lock 1 of the type depicted in FIG. 1 can then be used to keep the door panel in a closed position.

The lock 1 depicted in FIG. 1 comprises a coiled helical spring 3 that is provided with a first hook 5 at one end. The first hook is intended to be fixed to the door panel (not shown) so that the spring lies outside of the cage. Once fitted to the door, a user can extend the spring 3 using the finger pull 7 until a second hook 9 coupled to the opposite end of the spring 3 can be hooked over a wire of an adjacent mesh wall panel of the cage. In this position, the tensioned spring 3 tends to draw the two hooks together, and hence holds the overlapping door panel against the wall panel of the cage. As will be appreciated, the degree of tension depends on how far away the second hook is from the first hook 5 when it is coupled to the adjacent wall panel of the cage.

Whilst this arrangement can function, it has numerous disadvantages. Firstly, the efficacy of the seal of the door panel against the adjacent wall panel depends on the extent to which the spring 3 is tensioned, and hence on the extent to which a user can tension the spring (an adult, for example, will likely be more able to extend the spring to an appropriate degree than a child).

Secondly, the as the spring tends to act to draw the hooks together, it follows that such a lock is only really suitable for locking substantially parallel panels together. Were the lock to be used to connect two panels that meet at an angle, the tension in the spring would exert a force that tends to draw the panels parallel, thereby stressing the structure of the cage. This unduly limits the shape of the cage that can be constructed.

Finally, as the finger pull 7 tends to project outwardly from the door of the cage when the door is closed, it is possible for the lock to be disengaged if, for example, a user should knock against the finger pull 7.

The lock disclosed herein has been devised with aspects of the foregoing in mind.

### SUMMARY

In accordance with a presently preferred arrangement, there is provided a lock for an animal cage, the lock being configured for locking a first wire mesh panel of the cage to an adjacent second wire mesh panel, the lock comprising: a fastener for coupling the lock to said first panel in the vicinity of a peripheral edge of said first panel; a panel support for supporting a peripheral edge portion of said adjacent second wire mesh panel, and a two-part locking mechanism reconfigurable between a first position in which said peripheral edge portion of said adjacent second wire mesh panel is retained in said panel support and a second position where said peripheral edge portion of said adjacent second wire mesh panel can be moved out of said support.

Another implementation provides a lock for an animal cage that can be coupled to a wire mesh cage panel in any of a plurality of orientations. This is advantageous, compared to locks of the type shown in FIG. 1, as it allows a greater number of differently shaped cages to be constructed. Another envisaged implementation provides a lock for an animal cage that allows one panel to be orientated with respect to another at an angle selected from the range of between 45 and 225 degrees.

In one implementation said fastener may comprise first and second fastener portions that can be coupled around a wire of said first wire mesh panel to couple the lock to said first wire mesh panel. The lock may comprise first and second lock parts, a portion of said first lock part comprising said first fastener portion and a portion of said second lock part comprising said second fastener portion.

The panel support may comprise first and second support portions that cooperate to provide a support for a peripheral edge portion of said adjacent second wire mesh panel. The lock may comprise first and second lock parts, a portion of said first lock part comprising said first support portion and a portion of said second lock part comprising said second support portion.

In one implementation a first portion of said first lock part may comprise said first fastener portion and a second portion of said first lock part may comprise said first support portion, and a first portion of said second lock part may comprise said second fastener portion and a second portion of said second lock part may comprise said second support portion.

In one arrangement one said lock part may comprise a laterally extending shelf between the portions of the first and second lock parts that define the fastener and the portions of the first and second lock parts that define the support.

It is envisaged that one of said fastener portions may include a pair of wings configured to bear on adjacent parallel wires of said first wire mesh panel. Preferably the wings each include wire bearing surfaces that protrude from the said one fastener portion to bear on adjacent parallel wires of said first mesh panel. The wire bearing surfaces may be chamfered in the vicinity of said shelf to accommodate a peripheral wire of said first mesh panel that extends between said adjacent parallel wires of said first wire mesh panel.

The first and second fastener portions may each include a respective part of a two-part alignment system. The alignment system may comprise pins that extend from said one fastener portion to mate with tubes extending from the other fastener portion when the first and second fastener portions are coupled together.

In one arrangement the two-part locking mechanism comprises a locking arm and a keep, the arm being received in said keep in said first position. Preferably said locking arm is rotatable between said first and second positions.

The lock may further comprise a safety release that a user must operate before the locking arm can be rotated from said first position to said second position. The safety release may be urged by a resilient bias, responsive to movement of the locking arm from said second position to said first position, to move to a position where it resists movement of the locking arm from said first position to said second position. The safety release may comprise a button that can be depressed against said resilient bias to enable said locking arm to be rotated from said first position to said second position. Preferably the safety release is differently coloured to said locking arm so that users can visually identify whether said locking arm is in said first or said second position.

Preferably the lock is configured so that the lock can be coupled to said first wire mesh panel in any of a plurality of orientations. In one orientation a generally planar face of a part of said lock may lie in a plane defined by said first wire mesh panel when the lock is coupled thereto. In one orientation a generally planar face of a part of said lock may be generally orthogonal to a plane defined by said first wire mesh panel when the lock is coupled thereto.

Preferably the lock is configured so that the first and second wire mesh panels can pivot relative to one another when coupled together by means of the lock.

The lock may be configured so that the second wire mesh panel can be orientated relative to the first mesh panel at an angle A of between approximately 45 degrees and approximately 225 degrees when the panels are coupled together by means of the lock.

Another aspect of the present disclosure relates to an animal cage comprising a plurality of wire mesh panels, one of said panels being selectively coupled to another of said panels by means of a lock of the type described herein.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 is a perspective view of a previously proposed lock for an animal cage;

FIG. 2 is a perspective view of an animal cage with a closed access door;

FIG. 3 is a perspective view of the cage of FIG. 2 with the access door open;

FIG. 4 is a front perspective view of an animal cage lock of the type disclosed herein in an “open” configuration;

FIG. 5 is a rear perspective view of the lock depicted in FIG. 4;

FIG. 6 is an exploded front perspective view of the lock shown in FIG. 4;

FIG. 7 is an exploded rear perspective view of the lock shown in FIG. 5;

FIG. 8 is a rear perspective view of the lock in a “closed” configuration;

FIG. 9 is a diagrammatic representation of a manner by means of which a lock of the type disclosed herein can be attached to a wire mesh panel, and FIG. 10 shows the lock so attached;

FIG. 11 is a diagrammatic representation of the lock depicted in FIG. 10 in a closed configuration locking first and second panels together;

FIG. 12 is a diagrammatic representation of another manner by means of which a lock of the type disclosed herein can be attached to a wire mesh panel, and FIG. 13 shows the lock so attached;

FIG. 14 is a diagrammatic representation of the lock depicted in FIG. 13 in a closed configuration locking first and second panels together, and

FIGS. 15a and 15b are photographs depicting the range of relative movement available between two mesh panels that are coupled together by a lock of the type disclosed herein.

### DETAILED DESCRIPTION

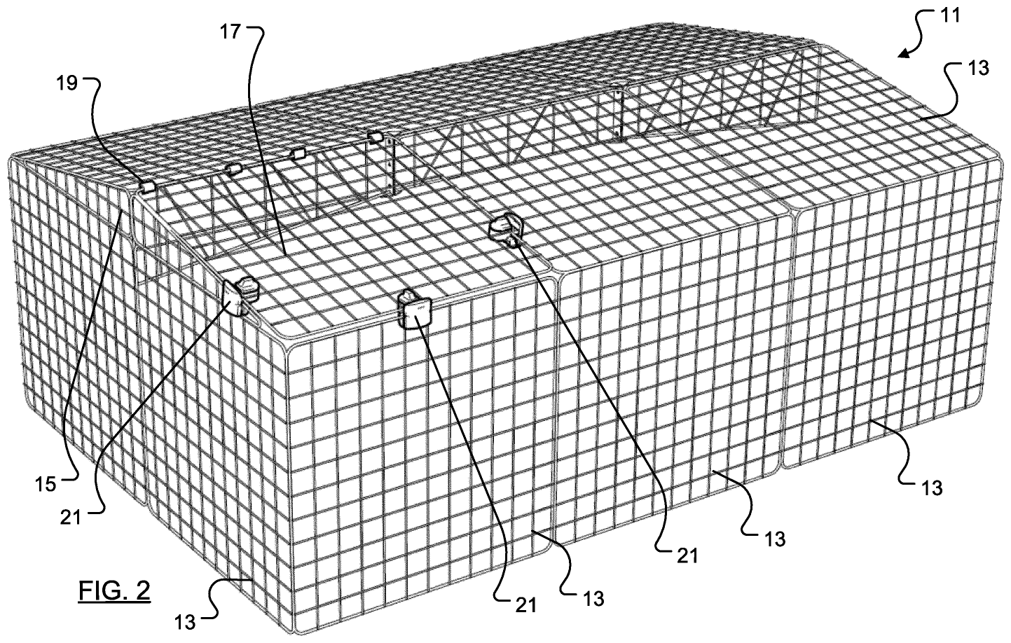

FIG. 2 is a schematic perspective view of an animal cage 11. The cage is comprised of a plurality of (in this implementation) identical rectangular wire mesh panels 13 that have been coupled together. The animal cage 11 has a pitched roof, enabled by triangular panels 15 at either end. The panels can be coupled together by any of a number of means known to persons of skill in the art, and for that reason the individual couplings are not shown. For example, the panels could be cable-tied together, coupled by ring clips or coupled by other types of fasteners.

As shown in FIG. 2, one of the aforementioned panels 13 is configured as a door 17, in this instance a door in the roof of the cage 11. The door 17 comprises a wire mesh panel that has been coupled at one side to an adjacent panel by means of a plurality of fasteners 19—in this particular example by means of ring clips of the type disclosed in our European Patent No. 3211251 (although other types of fasteners may instead be employed).

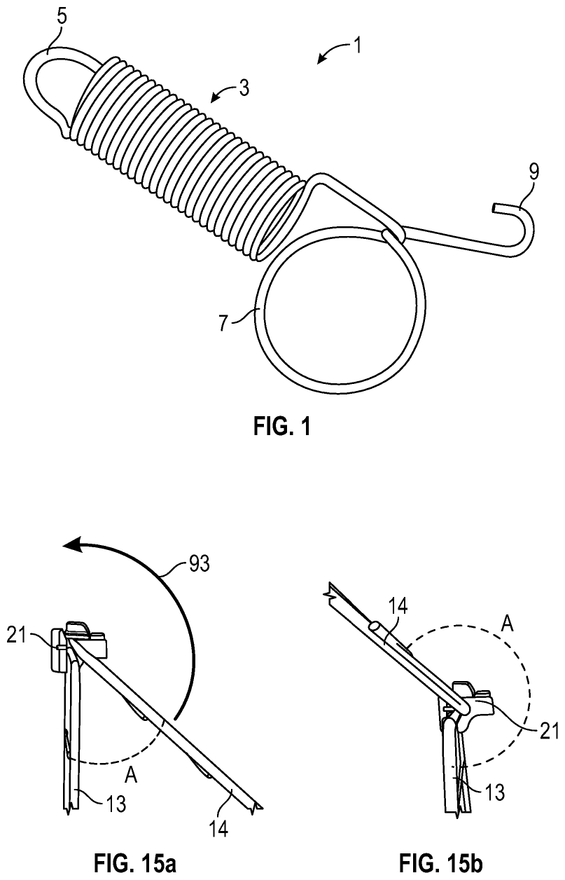

The remaining three sides of the door panel 17 are secured to adjacent panels 13 of the cage 11 by means of locks 21 of the type disclosed herein. In this particular example, three locks 21 are employed, but it will be appreciated that a greater or smaller number of locks may be employed if desired. Also of note is that the same types of lock are capable of coupling adjacent panels that are at a variety of angles to one another—in one example, panels that are substantially parallel, and in another example panels that are at an interior angle of less than 180 degrees to one another. An advantage of this feature is that the shape of cage that can be constructed is greatly increased as compared with the shape of cages that can be constructed using a lock of the type shown in FIG. 1.

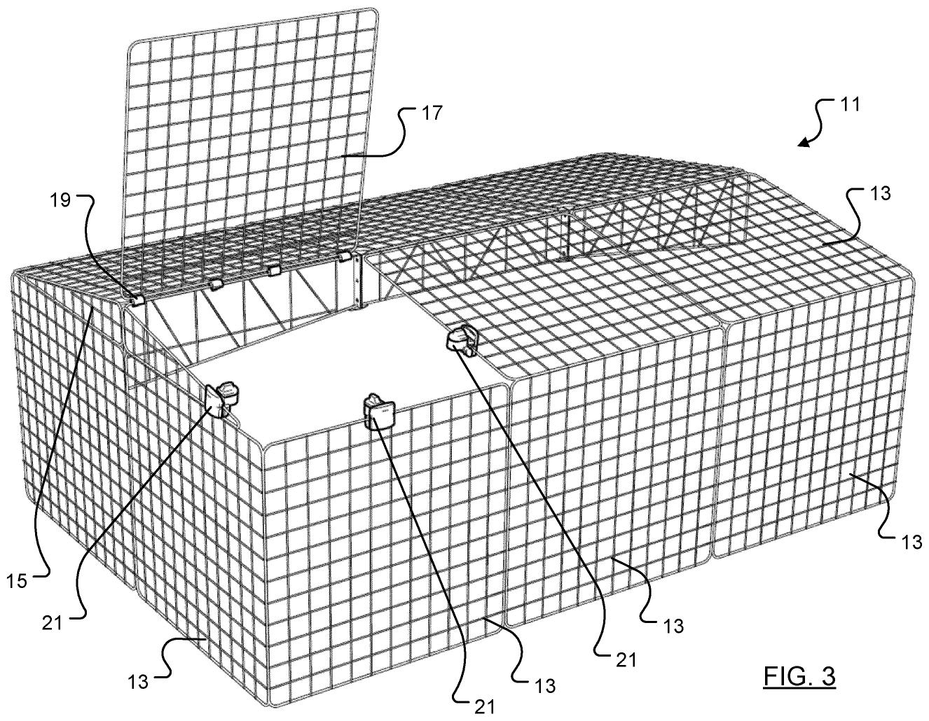

In FIG. 2, all three locks 21 are in a first “locked” or “closed” configuration. In this configuration the door panel 17 is supported on each of the three sides by the locks 21 and the locks 21 function to resist movement of the door panel 17 away from the adjacent panels 13. FIG. 3 is a schematic representation of the cage 11 when the locks 21 have been moved to a second “unlocked” or “open” configuration. In this configuration the door 17 can be moved freely to enable or block access to the interior of the cage 11.

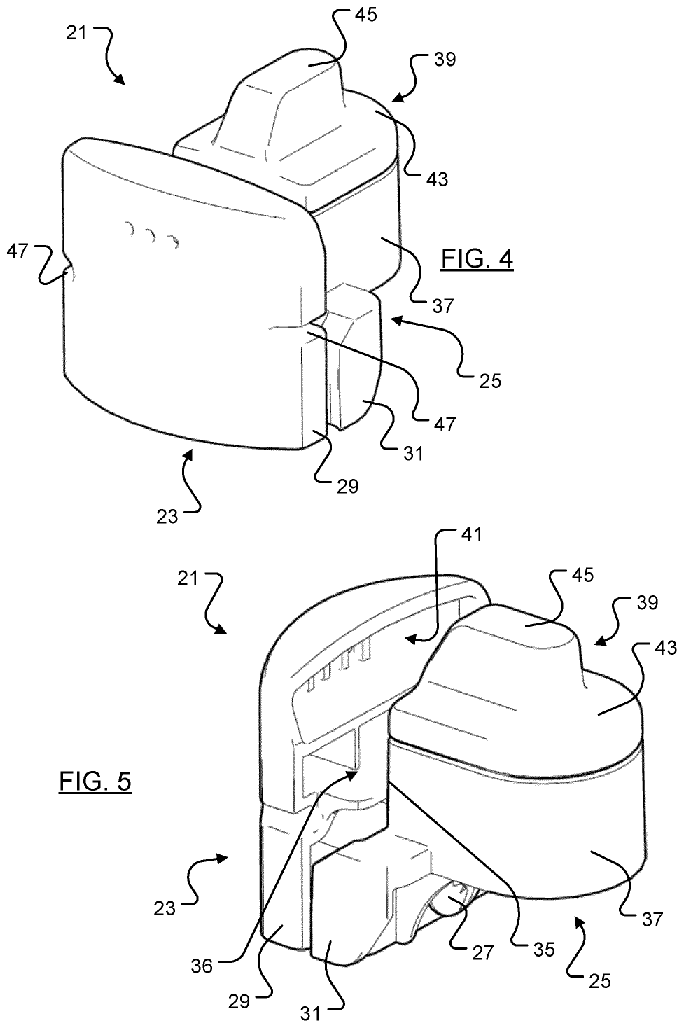

Referring now to FIGS. 4 and 5, there are depicted—respectively—front and rear perspective views of the lock 21. In this particular embodiment the lock 21 comprises a first lock part 23 and a second lock part 25 that can be coupled together around a wire of a wire mesh panel (typically a peripheral edge wire) by means of a releasable fixing 27, in this particular example a screw.

In this embodiment the first and second lock parts 23, 25 each include respective fastener portions 29, 31 that cooperate to provide a fastener that can be fastened around a wire of a wire mesh panel to securely couple the lock 21 to the panel. The first and second lock parts 23, 25 also include first and second support portions 33, 35 that cooperate, when the first and second lock parts 23, 25 are fastened together, to provide a support 36 for a wire of a wire mesh panel.

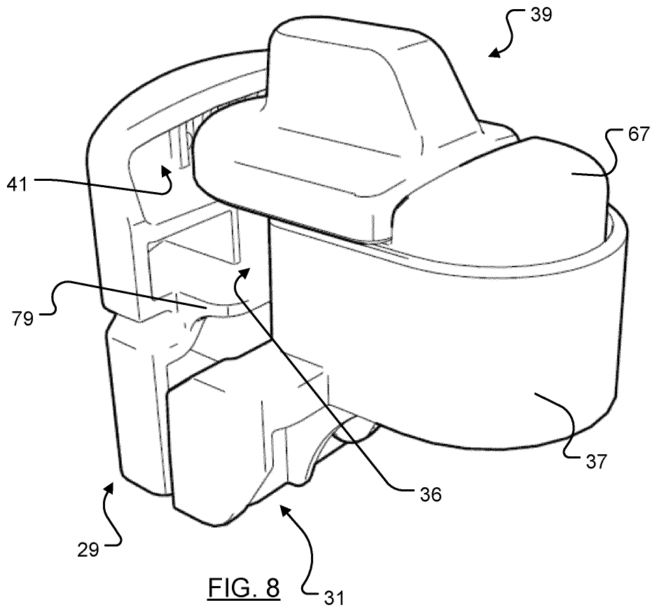

In this embodiment the second support portion 35 is provided in part by a housing 37 in which a rotatable locking member 39 is mounted. The rotatable locking member 39 forms one part of a two-part locking mechanism, the other part being a recess 41 formed in the first lock part 23. The recess is configured to receive an end portion 43 of the locking member 39 when the locking member is rotated, and when so rotated (as shown in FIG. 8, for example) the locking member 39 and recess cooperate to obstruct access to the aforementioned support, thereby trapping a wire of a wire mesh panel that might happen to be in the support and effectively locking that panel to the lock 21 (and hence to a panel to which the lock 21 is coupled). The locking member 39 is provided with a raised ridge 45 that can be grasped by a user when rotating the locking member 39 to obstruct or allow access to the support 36.

As best shown in FIG. 4, the first lock part 23 includes a pair of lateral grooves formed in opposite sides of the first part, the grooves being sized to accommodate a wire of a wire mesh panel so that the lock 21 can, as will later be described in detail, be orientated in any of a number of user-selected orientations with respect to the panel to which it is coupled.

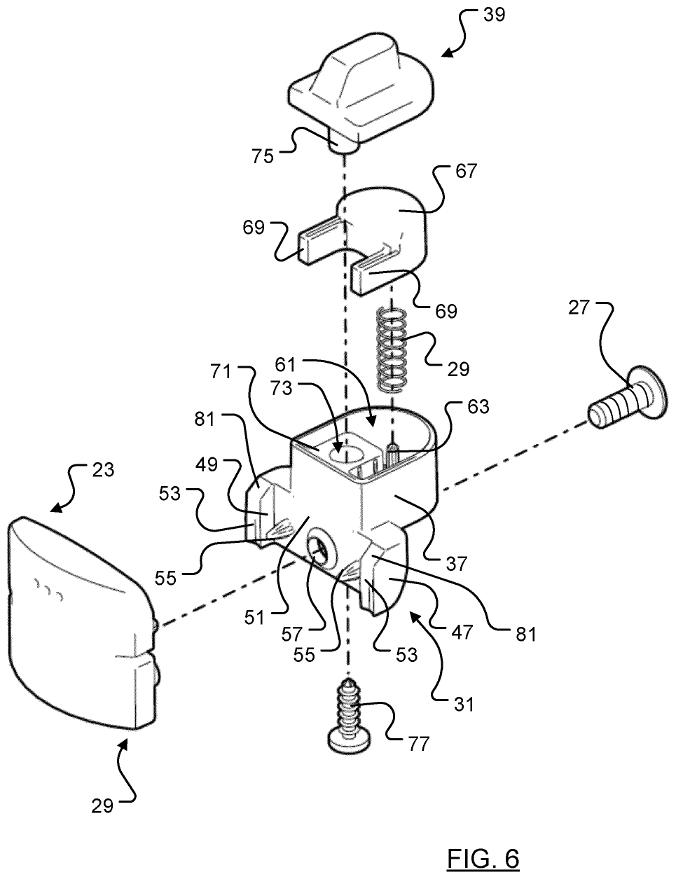

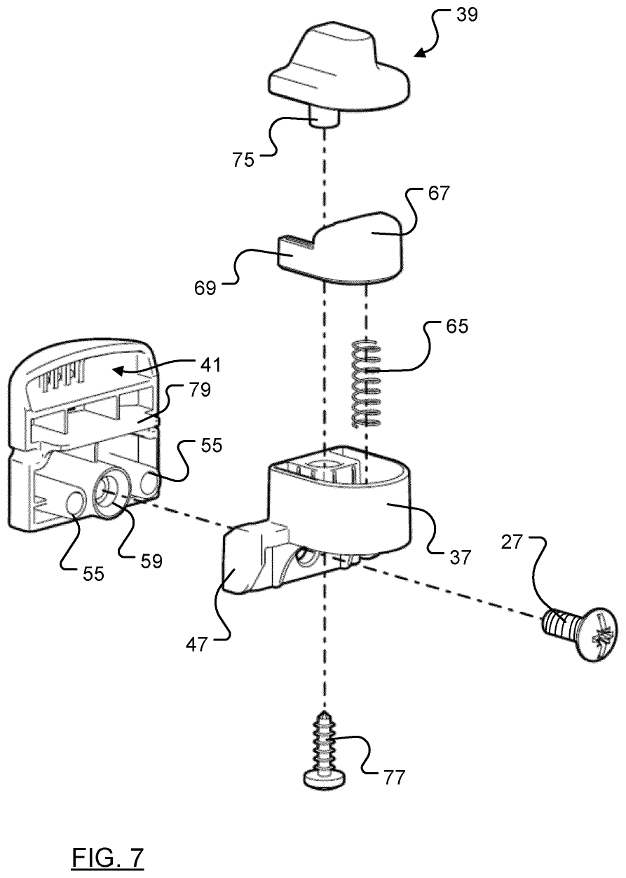

FIGS. 6 and 7 are, respectively, front and rear exploded perspective views of the lock 21.

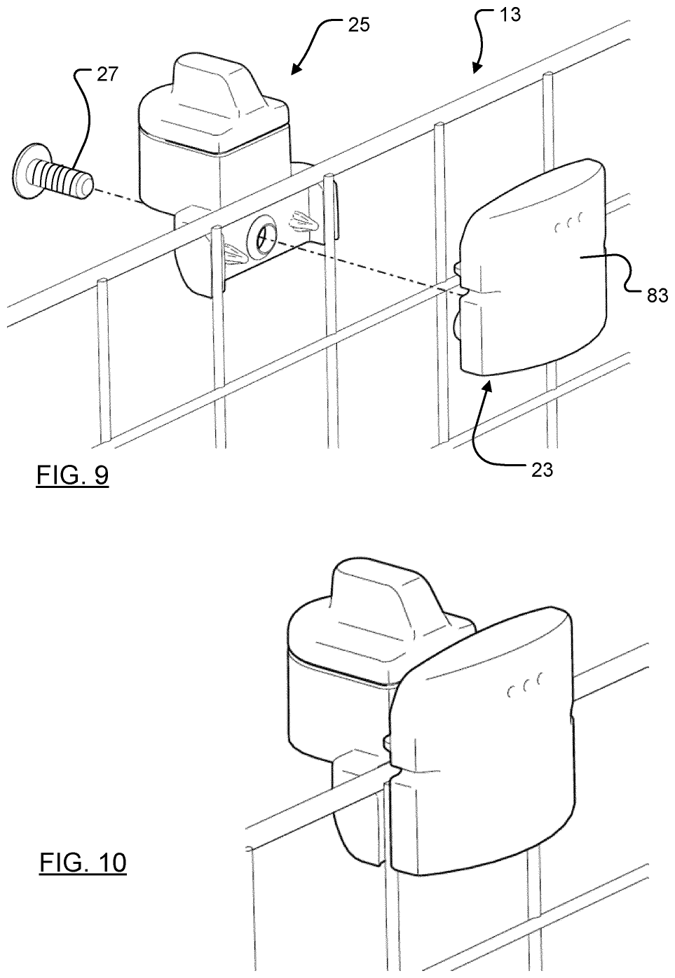

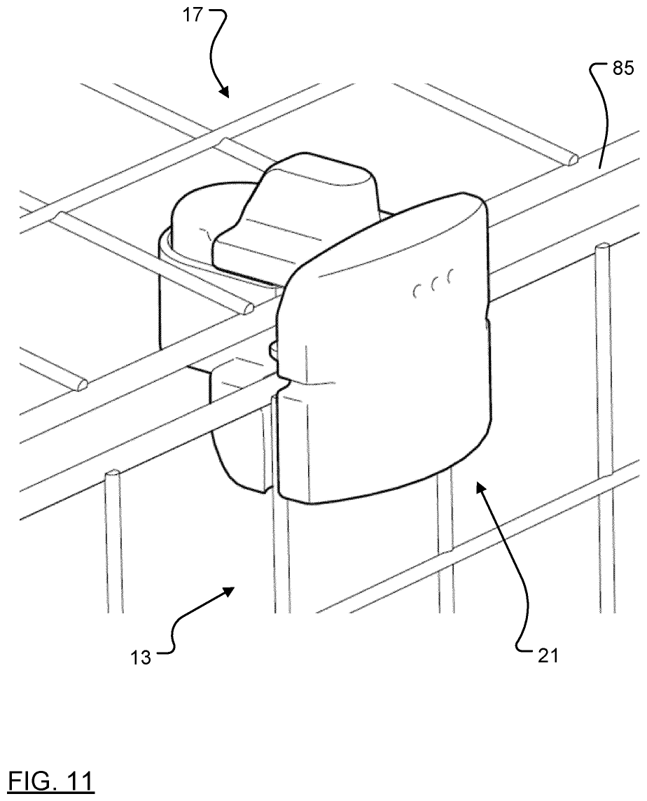

The fastener portion 31 of the second lock part 25 includes first and second lateral wings 47, 49 that are configured to bear against laterally adjacent wires of a wire mesh panel (as shown in FIG. 9, for example) in the vicinity of a peripheral edge wire of that panel. The wings 47, 49 protrude from a face 51 of the second lock part 31 and terminate in parallel wire bearing faces 53 that bear against the aforementioned wires of the panel when the lock 21 is fastened thereto. In an envisaged arrangement the wire bearing faces are slightly concave so that they better fit to the wires of the panel.

A pair of alignment formations 55 extend from the aforementioned face 51 of the second lock part 31. The alignment formations 55 are configured to be received in complementary tubular recesses 55 in the first lock part 29 when the first and second lock parts 29, 31 are secured together.

The face 51 of the second lock part also defines an aperture 57 through which the aforementioned fixing 27 can be fitted and engaged with a retainer 59 formed in the first lock part 29 when the two lock parts are brought together. In this instance the fixing comprises a screw, and the retainer comprises a complementarily internally threaded tube, but other appropriate fastener arrangements will be apparent to persons of skill in the art.

The aforementioned housing 37 includes an internal cavity 61 from a base of which a locating peg 63 projects. One end of a helical spring 65 is fitted over the locating peg 63 and arranged to bear on the underside of a depressable safety button 67 that includes a pair of legs 69 which fit either side of a fixing projection 71 provided within the cavity 61. The safety button 67 is, as is best shown in FIG. 7, taller than the legs 69 (in a direction towards the sheet number in the lock orientation shown in FIG. 7) so that a ledge is formed between the button 67 and legs 69. As will be appreciated, the helical spring 65 may be replaced with any type of suitable resilient bias, and the locating peg 63 may be adapted as required to accommodate such a bias.

The fixing projection includes a bore 73 that extends through the second lock part 25. The rotatable locking member 39 includes a retainer 75 that extends from the underneath of the locking member 39 and fits within the bore 73. A fixing 77, in this instance a screw, can be inserted into the bore for engagement with the retainer 75. In this position (namely, the aforementioned “open” position), as will be appreciated by persons of skill in the art, the rotatable locking member 39 acts to keep the safety button 67 compressed against the resilient bias 65.

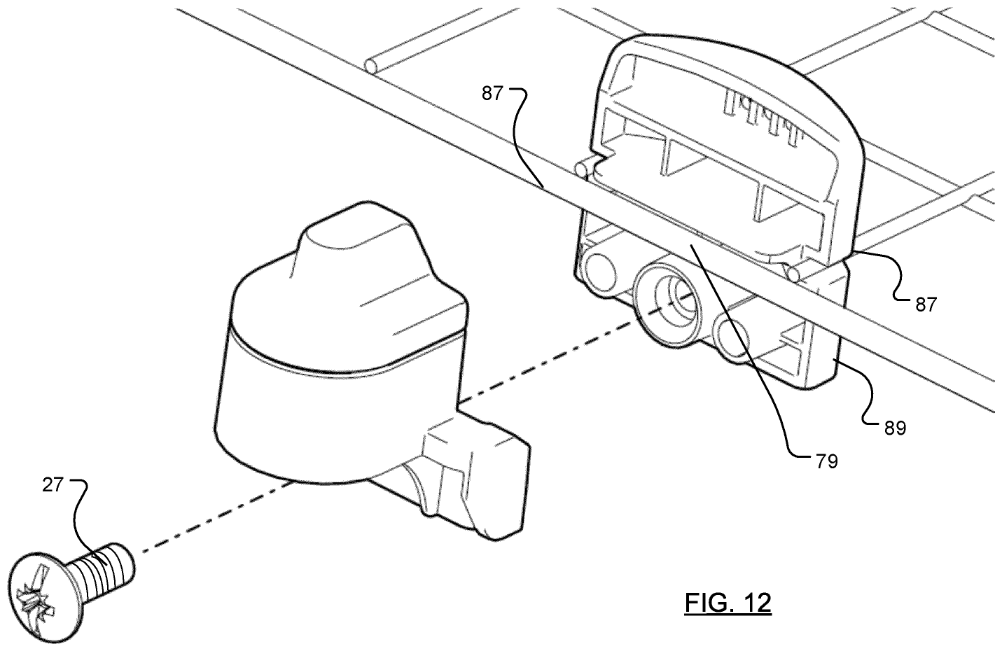

Referring now to FIG. 7 the first lock part 23 includes a laterally extending shelf 79 that cooperates with chamfered regions 81 of the wire bearing faces 53 to provide a channel for the receipt of a peripheral wire of a wire mesh panel (as depicted in FIG. 12), with wires orthogonal to the peripheral wire being engaged by the wire bearing faces 53.

As will be appreciated by persons of skill in the art, when the rotatable locking member is in the open position depicted in FIGS. 4 and 5, the locking member 39 acts against the bias of the spring 65 to keep the safety button 67 within the housing 37.

When the locking member 39 is rotated to be received within the recess 41, the resiliently biased safety button 67 is urged by the spring 65 to a position where the legs 69 of the button 67 bear against the underside of the locking member 39.

In this position, the button 67 acts to resist rotation of the locking member 39 back to the aforementioned “open” position. This feature is advantageous in that it requires the user to both push the button 67 and twist the locking member 39 before the locking member 39 can be returned to the “open” position, thereby helping to keep any animals within the cage 11 safe from predators.

In the preferred arrangement the safety button 67 is of a different colour to the remainder of the lock so that a user can quickly identify whether or not a given lock is in the open or closed position. In such an arrangement, if the lock is open the button is not visible. Whereas if the lock is closed, the coloured button 67 is visible and acts to resist movement of the locking member back to the open position.

Referring now to FIG. 8, there is depicted a lock 21 that is in the closed position with the end portion 43 of the locking member 39 received within the recess 41.

FIG. 9 is a diagrammatic representation of a manner by means of which a lock of the type disclosed herein can be attached to a wire mesh panel, and FIG. 10 shows the lock so attached.

Referring to FIG. 9, in a first step the user offers up the second lock part 25 to a peripheral region of a wire mesh panel 13 so that the wire bearing faces 53 abut against laterally adjacent wires of the mesh panel and a peripheral wire of the panel is received within the channel defined between the laterally extending shelf 79 and the chamfered regions 81 of the wire bearing faces 53.

Once so positioned, as depicted in FIG. 10, the second lock part can be fastened to the first lock part 23 by means of fixing 27 to securely couple the lock to the panel 13 in an orientation where the first lock part includes an outer face 83 that, at least approximately, lies in the plane of the panel.

Once the lock has been coupled to the first panel, a peripheral edge wire 85 of a second panel can be placed within the support and the locking member can be rotated to keep that edge wire within the support, and thereby couple the two panels together.

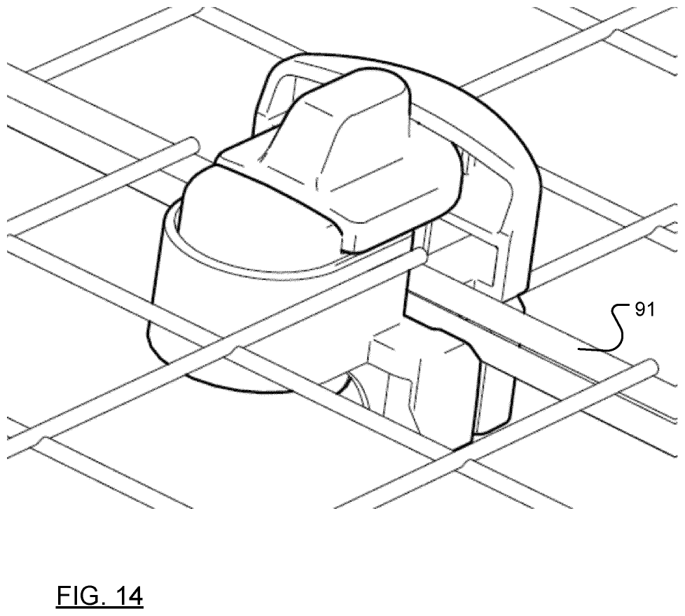

As the housing is smaller than the apertures defined by the wire mesh panels, such an arrangement—as shown schematically in FIGS. 15a and 15b—allows two panels 13, 14 to be coupled together by a lock 21 at any of a wide range of angles. At a minimum the panels can be configured so that one panel 14 is set at an angle A of approximately 45 degrees to the other panel 13, and that one panel 14 can then be rotated in the direction of arrow 93 whilst retained in the support of the lock 21 until it lies at an angle of approximately 225 degrees to the other panel 13. This arrangement facilitates the construction of a large number of differently shaped cages.

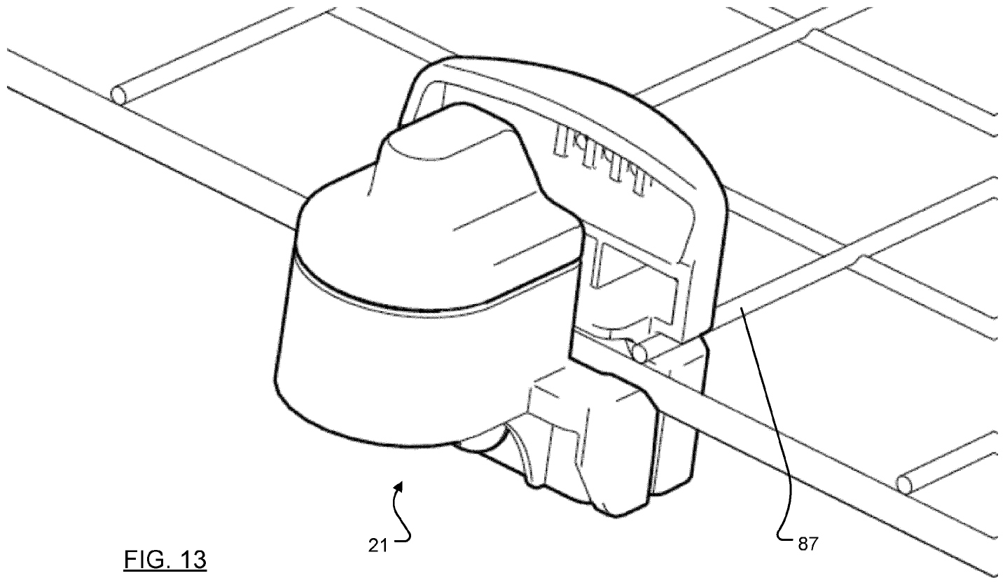

Referring now to FIGS. 12 to 14 of the drawings, the lock described herein can also be arranged so that the aforementioned face 83 of the first lock part is at least approximately orthogonal to the pane of the panel. In this implementation, the grooves 47 each receive one of an adjacent pair of wires 87 of the wire mesh panel, with a peripheral edge wire 89 of the panel received within the channel defined between the laterally extending shelf 79 and the chamfered regions 81 of the wire bearing faces 53.

In this configuration a peripheral edge wire 91 of a second panel can be received within the support so that the two panels are generally parallel to one another.

The locks described herein are durable and predator resistant whilst being easy for the user to operate. In addition, the provision of the safety button means that the user needs to push and turn simultaneously to open the lock—thereby helping to avoid accidental unlocking of the lock.

It will be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, whilst in the preferred embodiment the lock comprises first and second lock parts that cooperate to provide the fastener and panel support, it will be appreciated that whilst this implementation is preferred for manufacturing simplicity in the context of injection moulding (namely, avoiding undercuts) it is not essential. It is envisaged that the lock could comprise an inverted h-shaped second part which provides the support, and the first part could simply comprise a panel securable to the tail of the inverted h-shaped second part to clamp the lock to a given panel.

It should also be noted that whilst the accompanying claims set out particular combinations of features described herein, the scope of the present invention is not limited to the particular combinations hereafter claimed, but instead extends to encompass any combination of features herein disclosed.

Finally, it should be noted that any element in a claim that does not explicitly state “means for” performing a specified function, or “steps for” performing a specific function, is not to be interpreted as a “means” or “step” clause as specified in 35 U.S.C. Sec. 112, par. 6. In particular, the use of “step of” in the claims appended hereto is not intended to invoke the provisions of 35 U.S.C. Sec. 112, par. 6.

1-24. (canceled)

25. A lock for an animal cage, the lock being configured for locking a first wire mesh panel of the cage to an adjacent second wire mesh panel of the cage, the lock comprising:
a fastener for coupling the lock to said first panel in the vicinity of a peripheral edge of said first panel;
a panel support for supporting a peripheral edge portion of said adjacent second wire mesh panel, and
a two-part locking mechanism reconfigurable between a first position in which said peripheral edge portion of said adjacent second wire mesh panel is retained in said panel support and a second position where said peripheral edge portion of said adjacent second wire mesh panel can be moved out of said panel support.

26. A lock according to claim 25, wherein said fastener comprises first and second fastener portions that can be coupled around a wire of said first wire mesh panel to couple the lock to said first wire mesh panel.

27. A lock according to claim 26, wherein said lock comprises first and second lock parts, a portion of said first lock part comprising said first fastener portion and a portion of said second lock part comprising said second fastener portion.

28. A lock according to claim 27, wherein said panel support comprises first and second support portions that cooperate to provide a support for a peripheral edge portion of said adjacent second wire mesh panel.

29. A lock according to claim 28, wherein said lock comprises first and second lock parts, a portion of said first lock part comprising said first support portion and a portion of said second lock part comprising said second support portion.

30. A lock according to claim 29, wherein a first portion of said first lock part comprises said first fastener portion and a second portion of said first lock part comprises said first support portion, and a first portion of said second lock part comprises said second fastener portion and a second portion of said second lock part comprises said second support portion.

31. A lock according to claim 30, wherein one said lock part comprises a laterally extending shelf between the portions of the first and second lock parts that define the fastener and the portions of the first and second lock parts that define the support.

32. A lock according to claim 31, wherein one of said fastener portions includes a pair of wings, the wings each including wire bearing surfaces that protrude from the said one fastener portion to bear on adjacent parallel wires of said first mesh panel.

33. A lock according to claim 32 wherein said wire bearing surfaces are chamfered in the vicinity of said shelf to accommodate a peripheral wire of said first mesh panel that extends between said adjacent parallel wires of said first wire mesh panel.

34. A lock according to claim 26, wherein said first and second fastener portions each include a respective part of a two-part alignment system, said alignment system comprising pins that extend from said one fastener portion to mate with tubes extending from the other fastener portion when the first and second fastener portions are coupled together.

35. A lock according to claim 25, wherein said two-part locking mechanism comprising a locking arm and a keep, the arm being received in said keep in said first position, said locking arm being rotatable between said first and second positions.

36. A lock according to claim 35, comprising a safety release that a user must operate before the locking arm can be rotated from said first position to said second position.

37. A lock according to claim 36, wherein said safety release is urged by a resilient bias, responsive to movement of the locking arm from said second position to said first position, to move to a position where it resists movement of the locking arm from said first position to said second position.

38. A lock according to claim 37, wherein said safety release comprises a button that can be depressed against said resilient bias to enable said locking arm to be rotated from said first position to said second position.

39. A lock according to claim 36, wherein said safety release is differently colored to said locking arm so that users can visually identify whether said locking arm is in said first or said second position.

40. A lock according to claim 25, wherein said lock is configured so that the lock can be coupled to said first wire mesh panel in any of a plurality of orientations.

41. A lock according to claim 40, wherein the lock is configured so that the first and second wire mesh panels can pivot relative to one another when coupled together by means of the lock.

42. A lock according to claim 41, wherein the lock is configured so that the second wire mesh panel can be orientated relative to the first mesh panel at an angle A of between approximately 45 degrees and approximately 225 degrees when the panels are coupled together by means of the lock.

43. An animal cage comprising a plurality of wire mesh panels, one of said panels being selectively coupled to another of said panels by means of a lock according to claim 25.

44. A lock for an animal cage, the lock being configured for locking a first wire mesh panel of the cage to an adjacent second wire mesh panel of the cage, the lock comprising:
a fastener for coupling the lock to said first panel in the vicinity of a peripheral edge of said first panel, said fastener comprising first and second fastener portions that can be coupled around a wire of said first wire mesh panel to couple the lock to said first wire mesh panel;
a panel support for supporting a peripheral edge portion of said adjacent second wire mesh panel, said panel support comprising first and second support portions that cooperate to provide a support for a peripheral edge portion of said adjacent second wire mesh panel, and
a two-part locking mechanism reconfigurable between a first position in which said peripheral edge portion of said adjacent second wire mesh panel is retained in said panel support and a second position where said peripheral edge portion of said adjacent second wire mesh panel can be moved out of said panel support,
wherein said lock comprises first and second lock parts, a first portion of said first lock part comprising said first fastener portion and a first portion of said second lock part comprising said second fastener portion, a second portion of said first lock part comprising said first support portion and a second portion of said second lock part comprising said second support portion, said lock being configured so that the second wire mesh panel can be orientated relative to the first mesh panel at an angle A of between approximately 45 degrees and approximately 225 degrees when the panels are coupled together by means of the lock.
